(19) United States
(12) Patent Application Publication
(10) Pub. No.: US 2024/0013331 A1
(43) Pub. Date: Jan. 11, 2024

(54) COMPUTER-IMPLEMENTED SYSTEM AND METHOD FOR AUTOMATED DOCUMENTS MANAGEMENT

(71) Applicant: Bison Tech Solutions, Inc, West Hartford, CT (US)

(72) Inventor: John Fitzgerald Wachevsky, Panama City (PA)

(73) Assignee: Bison Tech Solutions, Inc, West Hartford, CT (US)

(21) Appl. No.: 18/213,330

(22) Filed: Jun. 23, 2023

Related U.S. Application Data
(60) Provisional application No. 63/388,004, filed on Jul. 11, 2022.

(51) Int. Cl. G06Q 50/20

(52) U.S. Cl. CPC G06Q 50/2057

(57) ABSTRACT

An automated documents management system may be configured to: enable an applicant user, such as a seafarer, to create, store, and access personal, career, and professional development information in the system database so that the applicant user can see all his documents and applications with their statuses in online format; enable an applicant user, such as a seafarer, to take online tests or examinations, via one or more client devices, instead of having to going offline and travel to special testing centers in order to earn a license, professional certification, or other credential that verifies someone's knowledge, skills and abilities to perform a specific job; and generate electronic documents, such as a license, professional certification, or other credential that verifies someone's knowledge, skills and abilities to perform a specific job which can then be verified in any point of the world if via an internet network connection.

### CROSS REFERENCE TO RELATED APPLICATIONS

This application claims priority to and the benefit of the filing date of U.S. Provisional Application No. 63/388,004, filed on Jul. 11, 2022, entitled “AUTOMATED PROFESSIONAL COMPETENCE ASSESSMENT SYSTEM”, which is hereby incorporated by reference in its entirety.

### FIELD OF THE INVENTION

This patent specification relates to the field of automated documents management systems and methods. More specifically, this patent specification relates to a computer-implemented system and methods for automated documents management which may be used in the training and certification of individuals, such as seafarers.

### BACKGROUND

Professional trade individuals, such as seafarers, are required to undergo training and certification typically receive hard copies of documents that prove they have completed this training and certification. However, hard copies of documents have many disadvantages, such as the possibility of becoming damaged, lost or stolen, being a work of forgery, and being difficult to replace. Additionally, these professional trade individuals must often submit a plurality of supporting documents in order to qualify and take many types of training, certification, testing, and other professional development education. Unfortunately, if one of these supporting documents is inadvertently omitted, it can create large delays and missed opportunities for a professional trade individual before they are able to retake the professional development education at a future date. Furthermore, in order to take a certification test, professional trade individuals must often travel to testing locations or testing centers which can be expensive and time consuming. All of these drawbacks can have serious detrimental career and income consequences for professional trade individuals.

Therefore, a need exists for a novel computer-implemented system and methods for automated documents management which may be used in the training and certification of individuals, such as seafarers, which do not suffer from the above-mentioned drawbacks and which are able to provide other novel functions.

### BRIEF SUMMARY OF THE INVENTION

An automated documents management system and methods are provided. Preferably, the system may be configured to solve problems in the field of training and certification of applicant users, such as seafarers, and the system may be utilized for the preparation and certification of applicant users of any country by allowing all standards of International Maritime Organization (IMO) Conventions. In further embodiments, the system is configured to: ensure the protection of system information from unauthorized access; ensure the integrity of the information processed by system components, such as servers and client devices, by implementing access delimitation functions; provide identification and authentication of applicant users and reviewing users; provide registration and processing of data on events in the system 100 related to information security; ensure the availability of information and software objects of protection for applicant users and reviewing users; ensure confidentiality of information processed by the components during operation due to implementation of access delimitation functions. At the same time, in the context of COVID-19 and other health pandemics, it is necessary for this system 100 to work in an online format.

According to an embodiment consistent with the principles of the invention, a computer implemented automated documents management system is provided. In some embodiments, the system may be configured to perform the steps of a method for professional competence management for an applicant user via a client device, and the system may include: a system database having a certification data record that may be associated with a plurality of certification requirement data records; program instructions stored in one or more computer-readable memories; and one or more processors configured to execute the program instructions to cause the system to perform operations that may include one or more of: receiving a digital picture of an applicant user, a digital copy of a passport of the applicant user, a digital copy of a medical record of the applicant user, a digital copy of an education record of the applicant user, and a digital copy of an experience record of the applicant user; generating an applicant data record for the applicant user in the system database, the applicant data record having a user image data record, an identification data record, a medical data record, an education data record, and an experience data record; receiving user input from the applicant user, via a first client device, to create an application to obtain a certification of the certification data record; generating an application data record in system database corresponding to the application, the application data record associated with the applicant data record; determining if the plurality of certification requirement data records are met by data of the medical data record, data of the education data record, and data of the experience data record; and generating a status data record that is associated with the application data record, in which the status data record includes data describing if the plurality of certification requirement data records are met by the data of the medical data record, data of the education data record, and data of the experience data record.

In further embodiments, the system may be configured to perform the steps of a professional competence assessment method, the certification data record may be associated with a certification test data record in the system database, the certification test data record having a plurality of questions and each question of the plurality of questions having a correct answer and one or more incorrect answers, and the one or more processors may be configured to execute the program instructions to cause the system to perform operations that may include one or more of: receiving user input from the applicant user, via a second client device, to take a test of the certification test data record; providing a confirmation code to the first client device; requiring the confirmation code to be entered via the second client device in order for the test of the certification test data record to be taken on the second client device; displaying the plurality of questions and the correct answer and one or more incorrect answers of each question of the plurality of questions of the certification test data record on a display screen of the second client device; recording, via the second client device, user input selecting one of the correct answer and one or more incorrect answers for one or more questions of the plurality of questions; counting down a time period that the user input selecting one of the correct answer and the one or more incorrect answers for one or more questions of the plurality of questions is allowed to be recorded in; determining that the test of the certification test data record is passed if a number of correct answers recorded via the second client device in the time period exceeds a correct answer threshold stored in the system database; and updating the education data record with data describing that the test of the certification test data record has been passed by the applicant user.

In further embodiments, the system may be configured to perform the steps of a professional competence document generation method, a certificate template may be stored in the system database and associated with the certification test data record, and the one or more processors may be configured to execute the program instructions to cause the system to perform operations that may include one or more of: populating a copy of the certificate template with a legal name of the applicant user stored in the applicant data record; and storing the copy of the certificate template populated with the user legal name as a certificate data record in the system database; applying an electronic signature to the certificate data record; receiving a request for data of the certificate data record from a third client device; determining that the third client device is authorized to receive data of the certificate data record; providing data of the certificate data record to the third client device if it is determined that the third client device is authorized to receive data of the certificate data record; and displaying the certificate data record having the user legal name and the electronic signature as an electronic document on a display screen of the third client device.

Numerous objects, features and advantages of the present invention will be readily apparent to those of ordinary skill in the art.

Some example objects of the present invention which improve the efficiency of servicing clients of various institutions and their registers include:

to provide a system that enables a reduction of the time of registration of applicant users' appeals due to the use of the function of data search and quick selection of information from the available directories and automatic formation of data on previously registered applicant users;

to provide a system that increases the reliability and expanding the amount and completeness of information to be provided to users at the expense of using information from the database of the system and providing the opportunity to use centralized information resources to institutions with appropriate access rights;

to provide a system that ensures prompt provision of electronic copies of publicly available documents based on test results to users, such as through the use of e-mail and the Internet;

to provide a system that provides prompt provision of profile certificates to users through the use of databases of regulatory and reference data of the system;

to provide a system that improves the quality, reduces time spent, and provides the ability to provide answers to interested organizations on the availability and legitimacy of documents of specialists, training and assessment of specialists; and

to provide a system that ensures the efficiency of preparation, testing and registration of its results.

Some example objects of the present invention which improve the efficiency of institutions in general include:

to provide a system that provides employees of institutions with the appropriate types of Automated Workplaces (AWP) of the System, necessary for them to perform their official duties;

to provide a system that reduces the total time from the moment of receipt of data on test results to the moment of response to the client's request to check the availability or legitimacy of test results by reducing the time of input, search and verification of data in a single database;

to provide a system that increases the efficiency of institutions and registers by reducing the time and reduce the amount of work to find information about test results and the formation of standard answers;

to provide a system that enables automatic receipt of data on issued documents from institutions, training centers and offices of educational institutions in a single database of documents in registers for further work (verification, adjustment and execution of requests);

to provide a system that expands the functions of various registers through the introduction of new types of services for clients, such as the establishment and operation of an advisory center; and

to provide a system that ensures the centralized accumulation and processing of information on the availability and legitimacy of documents issued to specialists based on test results.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in an automated documents management system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram showing some example software programs and components which may be found in an automated documents management system according to various embodiments described herein

FIG. 5 illustrates a block diagram showing an exemplary database structure of a system database which may be used in the system according to various embodiments described herein.

FIG. 6 shows a block diagram of an example of a computer-implemented method for professional competence management for an applicant user via a client device according to various embodiments described herein.

FIG. 7 depicts a block diagram of an example of a computer-implemented professional competence assessment method according to various embodiments described herein.

FIG. 8 illustrates a block diagram of an example of a computer-implemented professional competence document generation method according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 15% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software, with servers and client devices comprising exemplary computing devices.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anoto digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The terms “computer readable medium” and “computer readable memory” as used herein refers to any medium that participates in providing instructions to a processor for execution and/or participates in storing data which may be used by a processor. A computer readable medium or memory may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented automated documents management system and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

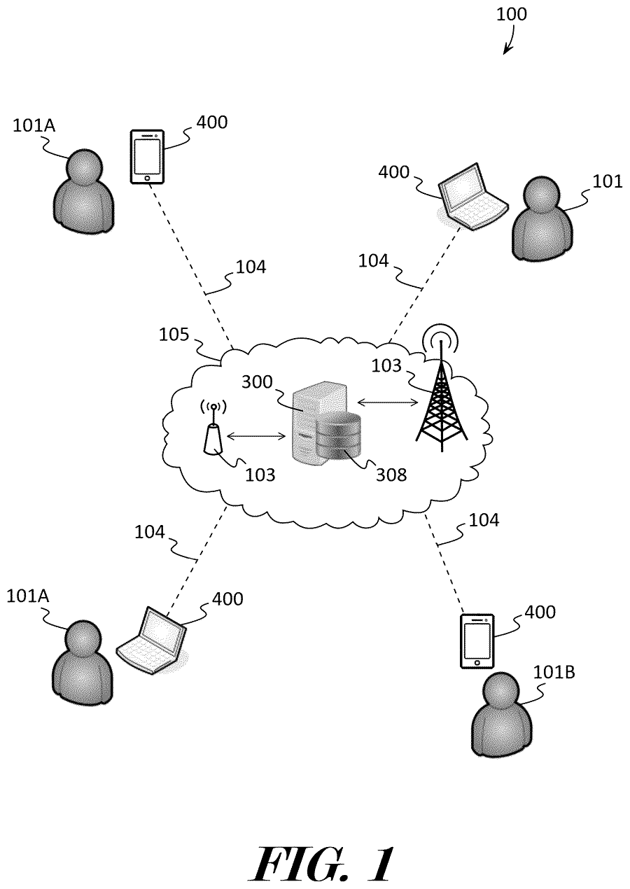

The present invention will now be described by example and through referencing the appended figures representing preferred and alternative embodiments. As perhaps best shown by FIG. 1, an illustrative example of some of the physical components which may comprise an automated documents management system (“the system”) 100 according to some embodiments is presented. The system 100 is configured to facilitate the transfer of data and information between one or more users 101 via client devices 400 and servers 300, 300A, over a data network 105. Client devices 400 and servers 300, 300A, may send data to and receive data from the data network 105 through a network connection 104 with an access point 103. One or more data stores 308 accessible by a system server 300A, may contain one or more system databases 120. The data of a system database 120 may comprise any information input into the system 100, including: including: information on or describing each user 101, such as user's 101 legal name, email, phone number, residence address, mailing address, etc.; information on or describing one or more client devices 400 of each user 101; a digital picture of one or more users 101; information describing a passport of one or more users 101, information describing a medical record of one or more users 101, information describing an education record of one or more users 101, and information describing an experience record of one or more users 101; one or more images of electronic documents generated by the system; and any other data and information described herein.

Client devices 400 and servers 300, 300A, may enable system 100 data exchange between users 101. In this example, the system 100 comprises at least one client device 400 (but preferably more than two client devices 400) configured to be operated by one or more users 101. Client devices 400 may include mobile devices, such as laptops, tablet computers, personal digital assistants, smart phones, and the like, that are equipped with a wireless network interface capable of sending data to one or more servers 300, 300A, with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300, 300A, with access to one or more data stores 308 over a wireless or wired local area network 105. The present invention may be implemented on at least one computing device, such as a client device 400 and/or server 300, 300A, programmed to perform one or more of the steps described herein. In some embodiments, more than one client device 400 and/or server 300, 300A, may be used, with each being programmed to carry out one or more steps of a method or process described herein.

In some embodiments, the system 100 may be configured to enable communication of information to and from one or more users 101 through their respective client devices 400, and servers 300A of the system 100. Users 101 of the system 100 may include one or more applicant users 101A and reviewing users 101B. An applicant user 101A may comprise an individual that is or that desires to be a professional trade individual, such as a seafarer, and who must obtain one or more licenses, certificates, undergo training and certification, and who must prove they have completed this training and certification. A reviewing user 101B may comprise an individual or entity that may need to verify and review licenses, certificates, training, and certification of one or more applicant users 101A.

In preferred embodiments, the system 100 may be configured to solve problems in the field of training and certification of applicant users 101A, such as seafarers, and the system 100 may be utilized for the Preparation and Certification of Seafarers of any Country by allowing all standards of International Maritime Organization (IMO) Conventions. In further embodiments, the system is configured to: ensure the protection of system information from unauthorized access; ensure the integrity of the information processed by system components, such as system servers 300A and client devices 400, by implementing access delimitation functions; provide identification and authentication of applicant users 101A and reviewing users 101B; provide registration and processing of data on events in the system 100 related to information security; ensure the availability of information and software objects of protection for applicant users 101A and reviewing users; ensure confidentiality of information processed by the components during operation due to implementation of access delimitation functions. At the same time, in the context of COVID-19 and other health pandemics, it is necessary for this system 100 to work in an online format.

In preferred embodiments, the system 100 is configured to generate electronic documents, manage electronic documents, and optimize electronic document flow between applicant users 101A and reviewing users 101B. In preferred embodiments, the system 100 is configured to allow an applicant user 101A and one or more reviewing users 101B view the applicant user's 101A existing documents and create applications for obtaining qualification documents. In preferred embodiments, the system 100 is configured to enable an applicant user 101A, such as a seafarer, to take online tests or examinations in order to earn a license, professional certification, or other credential that verifies someone's knowledge, skills and abilities to perform a specific job. Also, the system 100 is configured to ensure planning, organization, interaction and coordination of actions of structural divisions of the apparatus, territorial and interregional territorial bodies and other state authorities, e.g., state authorities of Ukraine or any other country or jurisdiction, regarding the implementation of international cooperation with competent bodies of foreign states and international organizations.

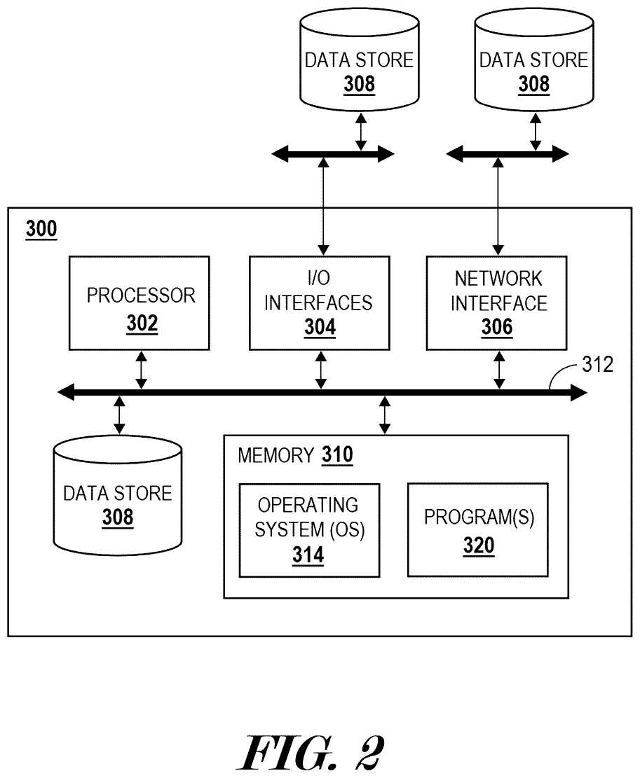

Referring now to FIG. 2, in an exemplary embodiment, a block diagram illustrates a server 300, 300A, of which one or more may be used in the system 100 or standalone and which may be a type of computing platform. A system server 300A is a server 300 that is configured to execute program instructions in order to perform one or more functions of the system 100. A server 300, 300A, may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300, 300A, in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing program instructions. When the server 300, 300A, is in operation, the processor 302 is configured to execute software or programs 320 stored within the memory 310, to communicate data to and from the memory 310, and to generally control operations of the server 300 pursuant to the software or program instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300, 300A, such as, for example, an internal hard drive connected to the local interface 312 in the server 300, 300A. Additionally, in another embodiment, the data store 308 may be located external to the server 300, 300A, such as, for example, an external hard drive connected to the I/O interfaces 304 (e.g., SCSI or USB connection). In a further embodiment, the data store 308 may be connected to the server 300, 300A, through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, WA), Solaris (available from Sun Microsystems, Inc. of Palo Alto, CA), LINUX (or another UNIX variant) (available from Red Hat of Raleigh, NC and various other vendors), Android and variants thereof (available from Google, Inc. of Mountain View, CA), Apple OS X and variants thereof (available from Apple, Inc. of Cupertino, CA), or the like.

The one or more programs 320 may comprise program instructions stored in one or more computer-readable memories and one or more processors 302 may be configured to execute the program instructions to cause the system 100 to perform operations described herein.

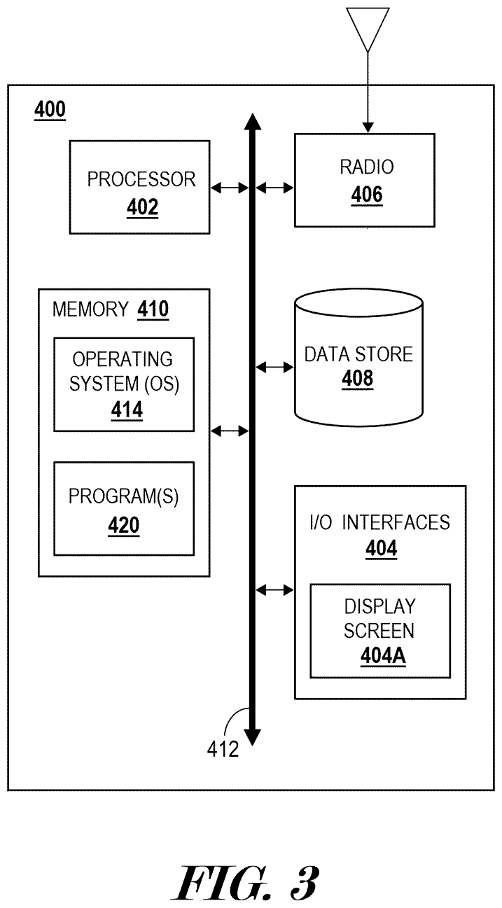

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing program instructions. When the client device 400 is in operation, the processor 402 is configured to execute software or programs 420, having program instructions, stored within the memory 410, to communicate data to and from the memory 410, and to generally control operations of the client device 400 pursuant to the software or program instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, barcode scanner, voice recognition, eye gesture, and the like. System output can be provided via a display screen 404A, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can display a graphical user interface (GUI) 181 that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The one or more programs 420 may comprise program instructions stored in one or more computer-readable memories and one or more processors 402 may be configured to execute the program instructions to cause the system 100 to perform operations described herein. The programs 420 may be configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to exchange information with the system 100.

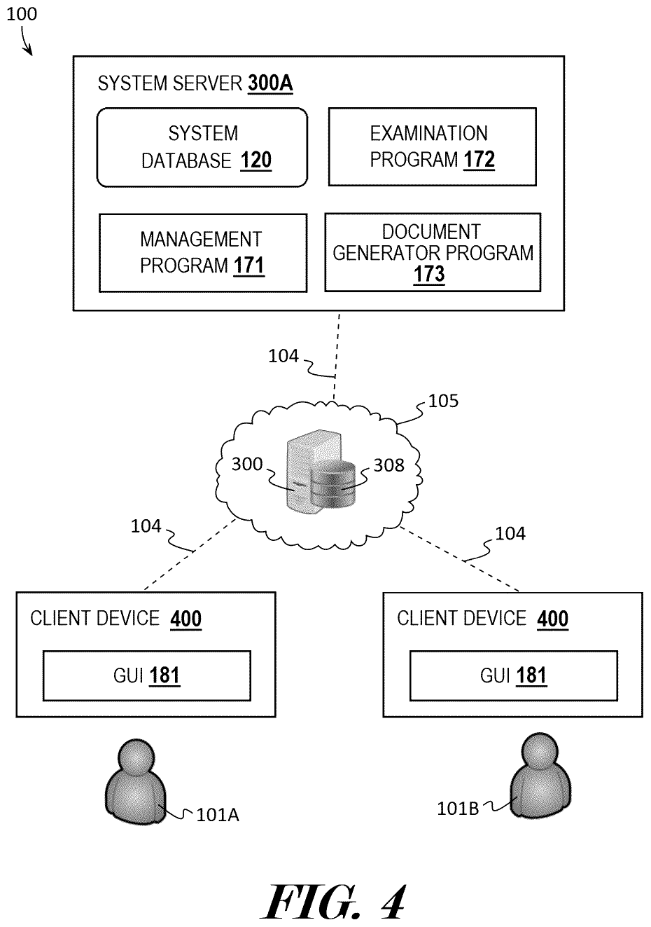

FIG. 4 depicts a block diagram showing some software programs 171, 172, 173, and components which may be found in a system 100 and which may optionally be configured to run on one or more system servers 300A and/or client devices 400 according to various embodiments described herein are illustrated. A system server 300A and client devices 400 preferably may be in wireless electronic communication through a network 105. The programs 171, 172, 173, may be in electronic communication so that data may be readily exchanged between the programs 171, 172, 173. Preferably, A system server 300A may be designed for user 101 interaction using the HTTPS protocol, and user 101 authentication may be performed using the Universal Second Factor (U2F) API extension. In preferred embodiments, programs 171, 172, 173, may provide system 100 access to users 101 via a web browser, application, or other method of generating or displaying a graphical user interface 181 on a client device 400. Preferably, protection of information transmitted between the client devices 400 and servers 300, 300A, may be carried out using SSL, TLS protocols that are part of HTTPS.

In this and some embodiments, one or more system servers 300A may be configured to run a management program 171, an examination program 172, and a document generator program 173, and one or more of the programs 171, 172, 173, may be configured to generate a graphical user interface 181 on the display screens 404A of client devices 400A which may be used to receive user input and display system output and data. In preferred embodiments, one or more of the programs 171, 172, 173, may be configured to generate a web based graphical user interface 181 on the display screens 404A of client devices 400A. In further embodiments, a management program 171, an examination program 172, and a document generator program 173, may be configured to run on one or more system servers 300A, such as by being cloud based, and/or client devices 400, such as by being local to client device(s) 400 of a user 101, according to various embodiments described herein. It should be understood that the functions attributed to the programs 171, 172, 173, described herein are exemplary in nature, and that in alternative embodiments, any function attributed to any program 171, 172, 173, may be performed by one or more other programs 171, 172, 173, or any other suitable processor logic.

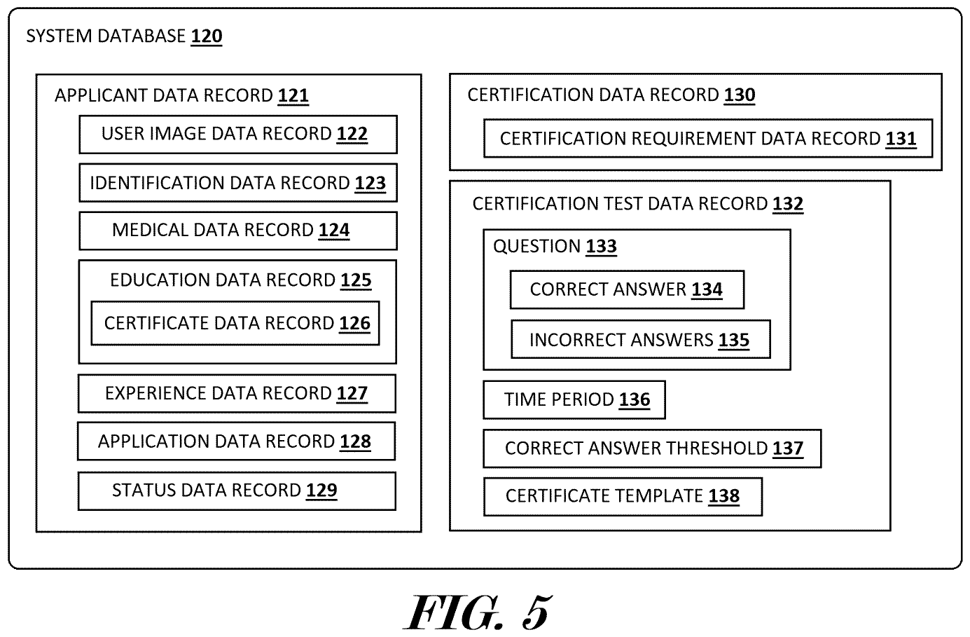

FIG. 5 depicts a block diagram showing an exemplary database structure of a system database 120 which may be used in the system 100 according to various embodiments described herein is illustrated. The system 100 may comprise a system database 120 which may be stored on a data store 308 of a system server 300A that may be accessible to the programs 171, 172, 173. In preferred embodiments, the system database 120 may be encrypted, such as via the SHA256 computational algorithm, or any other Symmetric Encryption or Asymmetric Encryption protocol. In preferred embodiments, a system database 120 may have a database level that comprises a database management system (hereinafter referred to as DBMS); PostgreSQL may be used as DBMS although other DBMS types may be used. Preferably, the system database 120 may be relational, and all data is recorded in a table.

In some embodiments, a system database 120 may comprise any information input into and generated by the system 100, including: information on or describing each user 101, such as user's 101 legal name, email, phone number, residence address, mailing address, etc.; information on or describing one or more client devices 400 of each user 101; a digital picture of one or more users 101; information describing a passport of one or more users 101, information describing a medical record of one or more users 101, information describing an education record of one or more users 101, and information describing an experience record of one or more users 101; one or more images of electronic documents generated by the system; and any other data and information described herein. It should be understood that the described structure of the system database 120 is exemplary in nature, and that in alternative embodiments, the data contained within the system database 120 may be organized in any other way.

A system database 120 may comprise a plurality of applicant data records 121, and each applicant data record 121 may comprise data describing an applicant user 101A, such as the applicant user's name 101A, date of birth and age, email address, phone number, residence address, mailing address, etc. Preferably, a user image data record 122, an identification data record 123, a medical data record 124, an education data record 125, an experience data record 127, and an application data record 128 may be associated with applicant data record 121. A user image data record 122 may comprise one or more digital images, videos, etc., of the applicant user 101A which may be received by the system 100. An identification data record 123 may comprise digital images of one or more government identification documents, such as a passport, driver's license, seafarer's passport, etc. Optionally, an identification data record 123 may comprise digital images of one or more private identification documents, such as a company identification card. A medical data record 124 may comprise data describing medical data of the applicant user 101A, such as height, weight, medical conditions, medical restrictions, current medications, medication history, medical procedure history, medical certificates, vision test results, etc. An education data record 125 may comprise data describing the educational history of the applicant user 101A, such as primary and secondary educational history, trade school education history, professional development courses and classes, etc. An education data record 125 may comprise one or more certificate data records 126, and each certificate data record 126 may comprise a digital image of a certificate, certification document, etc., that the applicant user 101A has earned by completing one or more training courses and/or examinations. An experience data record 127 may comprise data describing the experience or work history of the applicant user 101A, such as data describing duties performed, titles earned, time periods of occupation, of one or more internships, employment positions, volunteer positions, etc. An application data record 128 may comprise data describing an application that the applicant user 101A desires to complete in order to earn a certification certificate or in order to qualify to take an examination for earning a certification certificate, such as received in the successful completion of professional development education. Each application data record 128 may be associated with a status data record 129, and a status data record 129 may comprise data describing if the plurality of certification requirement data records 131 of a certification data record 130 are met by the data of the medical data record 124, data of the education data record 125, and data of the experience data record 127.

A system database 120 may comprise a plurality of certification data records 130, and each certification data record 130 may comprise data describing a certificate that may be earned by an applicant user 101A for the successful completion of professional development education, typically requiring the passing of a certification test or examination. As used herein, a certificate is a document describing a license, professional certification, or other credential that verifies someone's knowledge, skills and abilities to perform a specific job. Certifications and licenses are typically awarded by a professional association after a candidate completes an assessment of some kind. Each certification data record 130 may be associated with one or more, such as a plurality of certification requirement data records 131. Each certification requirement data record 131 may comprise data describing an educational prerequisite, an experience prerequisite, or other requirement that an applicant user 101A must have or achieve in order for the applicant user 101A for the successful completion of professional development education, typically enabling the applicant user 101A to sit for or take a certification test or examination. For example, in order to earn a captain's license, an individual must have one or more educational prerequisites and experience prerequisites in order to take a test that, when passed, will result in the captain's license being awarded to the individual. In this example, the certification data record 130 may contain data describing the captain's license and the certification requirement data records 131 may each describe a prerequisite that is required in order to take the captain's license test.

A system database 120 may comprise a plurality of certification test data records 132, and each certification data record 130 and be associated with a certification test data record 132. Each certification test data record 132 may comprise data describing a test or examination that an applicant user 101A may take and pass in order to earn a license, professional certification, or other credential that verifies someone's knowledge, skills and abilities to perform a specific job. A plurality of questions 133 may be associated with the certification test data record 132, and each question 133 may comprise a knowledge challenge question that may be presented to an applicant user 101A when taking a test of the certification test data record 132. Each question 133 may be associated with a correct answer 134 and one or more incorrect answers 135. A correct answer 134 may comprise data describing the correct answer to a question 133, while an incorrect answer 135 may comprise data describing an answer that is not the correct answer to a question 133. Generally, an applicant user 101A taking a test of a certification test data record 132 may be presented with a number of questions 133 and their respective correct answer 134 and one or more incorrect answers 135 on a display screen 404A of a client device 400. To successfully answer a question 133, the applicant user 101A must provide user input, via their client device 400, selecting the correct answer 134 as being the correct answer to the question 133. The certification test data record 132 may be associated with a time period 136. A time period 136 may describe an amount of time that the applicant user 101A has in order to select correct answer(s) 134 within, and the time period 136 may commence at the start of the test of the certification test data record 132 or commence at the presentation of one or more sets of questions 133. Once the time period 136 is exceeded, the ability of the applicant user 101A to select correct answer(s) 134 may be stopped and preferably the test may be ended. A correct answer threshold 137 may be associated with each certification test data record 132, and the correct answer threshold 137 may comprise data describing the minimum number of correct answers 134 that the applicant user 101A is required to have selected in order to have passed the test of the certification test data record 132. For example, if the correct answer threshold 137 is eighty percent, the applicant user 101A is required to have selected the correct answer 134 for at least eighty percent of the questions 133 of the test of the certification test data record 132. A certificate template 138 may be associated with each certification test data record 132, and the certificate template 138 may comprise data which may be used to generate an image of a certificate, license, or other document that identifies an individual as having successfully passed a test or examination for a license, professional certification, or other credential that verifies someone's knowledge, skills and abilities to perform a specific job. Once the certificate template 138 is populated with the name of an applicant user 101A, one or more electronic signatures, and/or any other data, such as date of completion, certificate or license number, etc., it may be saved as a certificate data record 126 in the applicant data record 121 and displayed on a client device 400 of the system 100 as proof that the applicant user 101A has passed an examination and earned a license, professional certification, or other credential that verifies someone's knowledge, skills and abilities to perform a specific job.

In preferred embodiments, the system 100 may include a management program 171 which may comprise program instructions stored in one or more computer-readable memories 310, 410, and executable by one or more processors 302, 402. Preferably, a management program 171 may be executable by a processor 302 of a system server 300A. A management program 171 may be configured to add, delete, and modify data in the system database 120. A management program 171 may determine if certification requirement data records 131 are met by data of an applicant data record 121 of an applicant user 101A. A management program 171 may be configured to generate and operate a graphic user interface on a client device 400 in order to receive user input and to display user output, such as to display an output describing if certification requirement data records 131 are met or are not met by the data of applicant data record 121, and to receive user input from a client device 400 of an applicant user 101A to take a test of a certification test data record 132. A management program 171 may be configured to process requests for data of certificate data records 126, and optionally other records of applicant data records 121, via a client device 400.

In some embodiments, a management program 171 may be configured to use the data of an applicant data record 121 to generate a graphical user interface 181 on a client device 400 of an applicant user 101A, optionally as a web page, that may have the data organized by menus that may include: statements; service books; certificates; educational documents; medical certificates; seafarer's passport; qualification documents; certificate of seniority; and submission of an application. Statements may contain a list of applications having: statements of the Seafarer qualification data (SQC); applications for qualification; and applications for seafarer's record books. Service books may contain the seafarer's record books. Certificates may include a list of received certificates, such as certificates generated by the system 100. Educational documents may contain a list of educational documents issued to the applicant user 101A, such as by the Ministry of Education of Ukraine, etc. Medical certificates may contain a list of medical certificates of the applicant user 101A. Applicant user's passport may contain information on the applicant user's 101A passport. Qualification documents may contain documents, such as received from SQC. Certificate of seniority may contain records of applicant user's 101A experience. Submission of application allows for the creation of applications for obtaining documents, such as for the creation of application data records 128. A management program 171 may also be configured to perform other functions as described herein.

In preferred embodiments, the system 100 may include an examination program 172 which may comprise program instructions stored in one or more computer-readable memories 310, 410, and executable by one or more processors 302, 402. Preferably, an examination program 172 may be executable by a processor 302 of a system server 300A. An examination program 172 may be configured to display questions on an applicant user's 101 client device 400 and receive user selected answers from an applicant user's 101 client device 400. An examination program 172 may be configured to determine if a test of a certification test data record 132 is passed by an applicant user 101A and to update the applicant user's 101A applicant data record 121 accordingly. An examination program 172 may also be configured to perform other functions as described herein.

In preferred embodiments, the system 100 may include a document generator program 173 which may comprise program instructions stored in one or more computer-readable memories 310, 410, and executable by one or more processors 302, 402. Preferably, a document generator program 173 may be executable by a processor 302 of a system server 300A. A document generator program 173 may be configured to generate electronic documents for applicant users 101A and to display electronic documents to users 101, such as applicant users 101A and reviewing users 101B, that are authorized to view the electronic documents. A document generator program 173 may also be configured to perform other functions as described herein.

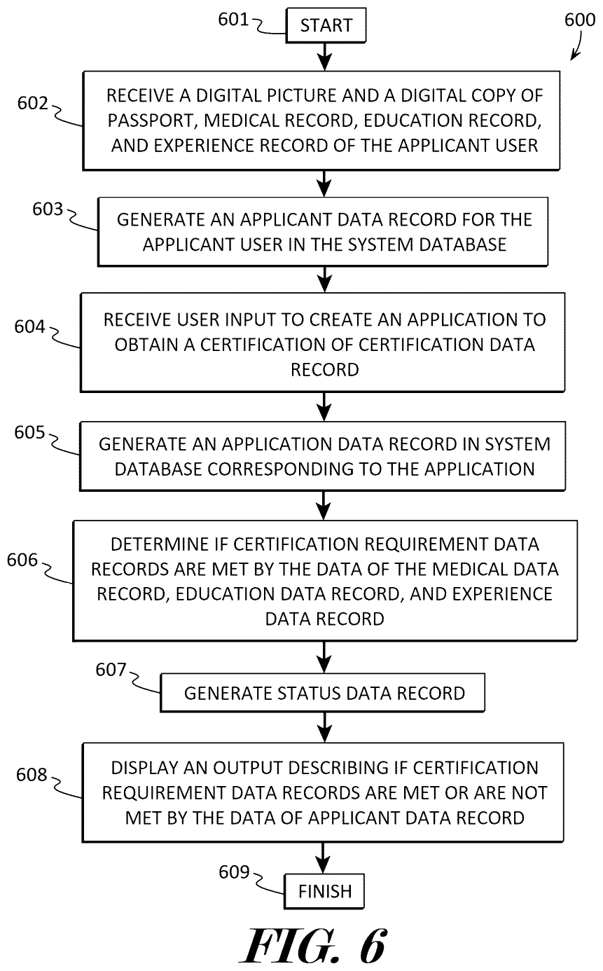

FIG. 6 shows a block diagram of an example of a computer-implemented method for professional competence management for an applicant user 101A via a client device 400 (“method 600”) according to various embodiments described herein. Preferably, the method 600 may be used to enable an applicant user 101A, such as a seafarer, to create, store, and access personal, career, and professional development information in the system database 120 so that the applicant user 101A can see all his documents and applications with their statuses in online format. Preferably, the method 600 may be used to enable an applicant user 101A to create one or more applications, such as which may be needed in order to reach one a target goal of “Receive working documents which give seafarer a possibility to work for international companies according International Maritime Organization (IMO) standards”. Program instructions, such as contained in a management program 171, an examination program 172, and a document generator program 173 and stored in one or more computer-readable memories 310, 410, may be executed via one or more processors 302, 402, to cause the system 100 to perform the steps of method 600.

The method 600 may start 601 and the system 100 may receive a digital picture of an applicant user 101A, a digital copy of a passport of the applicant user 101A, a digital copy of a medical record of the applicant user 101A, a digital copy of an education record of the applicant user 101A, and a digital copy of an experience record of the applicant user 101A in step 602. In preferred embodiments, a management program 171 may receive the digital copies from one or more government agency software systems, medical provider software systems, educational institution software systems, professional development agency software systems, or other software systems, by being downloaded via network connection 104 with the respective software systems. In further embodiments, the digital copies may be uploaded via a client device 400 of an applicant user 101A or other user 101.

In step 603, an applicant data record 121 for the applicant user 101A may be generated in the system database 120 by the management program 171. In preferred embodiments, the applicant data record 121 may include a user image data record 122, an identification data record 123, a medical data record 124, an education data record 125, and an experience data record 127. The management program 171 may use data of the digital picture of an applicant user 101A, data of the digital copy of a passport of the applicant user 101A, data of the digital copy of a medical record of the applicant user 101A, data of the digital copy of an education record of the applicant user 101A, and data of the digital copy of an experience record of the applicant user 101A to populate the user image data record 122, an identification data record 123, a medical data record 124, an education data record 125, and an experience data record 127. Once the applicant data record 121 for the applicant user 101A is generated in the system database 120, the management program 171 may generate a graphical user interface 181 on the client device 400 of the applicant user 101A that displays data of the applicant data record 121.

In step 604, user input to create an application to obtain a certification of a certification data record 130 may be received from an applicant user 101A via a client device 400 of the applicant user 101A. The system database 120 may comprise a plurality of certification data records 130, and each certification data record 130 may comprise data describing a certificate that may be earned by an applicant user 101A for the successful completion of professional development education, typically requiring the passing of a certification test or examination. In some embodiments, the management program 171 may generate a graphical user interface 181 on the display screen 404A of the applicant user's 101A client device 400 which the applicant user 101A may interact with to provide the user input to create an application to obtain a certification of a certification data record 130.

In step 605, an application data record 128 may be generated in the system database 120 corresponding to the application by the management program 171, and the management program 171 may associate the application data record 128 with the applicant data record 121 in the system database 120. An application data record 128 may comprise data describing an application that the applicant user 101A desires to complete (determined by user input entered in step 604) in order to earn a certification certificate or in order to qualify to take an examination for earning a certification certificate, such as received in the successful completion of professional development education of a certification data record 130.

In step 606, the management program 171 may determine if the certification requirement data records 131 of the certification data record 130 associated with the application data record 128 are met by data of the medical data record 124, data of the education data record 125, and/or data of the experience data record 127. Each certification data record 130 may be associated with one or more, such as a plurality of certification requirement data records 131. Each certification requirement data record 131 may comprise data describing an educational prerequisite, an experience prerequisite, or other requirement that an applicant user 101A must have or achieve in order for the applicant user 101A for the successful completion of professional development education, typically enabling the applicant user 101A to sit for or take a certification test or examination. As an example, if a certification requirement data record 131 comprises an educational prerequisite of a Bachelor's degree, and the education data record 125 comprises data describing a Bachelor's degree, the management program 171 may determine that the certification requirement data record 131 is met by data of the education data record 125. As another example, if a certification requirement data record 131 comprises an experience prerequisite of having a number of hours of experience in an occupational position, and the experience data record 127 does not comprise data describing the applicant user 101A has at least that number of hours of experience in the occupational position, the management program 171 may determine that the certification requirement data record 131 is not met by data of the education data record 125.

In step 607, a status data record 129 may be generated in the system database 120 by the management program 171, and the management program 171 may associate the status data record 129 with the application data record 128. The status data record 129 may comprise data describing if the plurality of certification requirement data records 131 of the certification requirement data record 131 are met by the data of the medical data record 124, the data of the education data record 125, and/or the data of the experience data record 127.

In step 608, an output describing if the certification requirement data records 131 are met or are not met by the data of the medical data record 124, the data of the education data record 125, and/or the data of the experience data record 127 may be provided to the client device 400 of the applicant user 101A. In preferred embodiments, the management program 171 may generate a graphical user interface 181 on the display screen 404A of the applicant user's client device 400 which may display the output describing if the certification requirement data records 131 are met or are not met by the data of the medical data record 124, the data of the education data record 125, and/or the data of the experience data record 127.

In some embodiments, the output of step 608 may comprise data describing that each certification requirement data record 131 of the plurality of certification requirement data records 131 of the certification data record 130 is not met by one or more of the data of the medical data record 124, the data of the education data record 125, and the data of the experience data record 127. As an example, the output may comprise text telling the applicant user 101A that they don't meet all of the requirements to take the test of a certification test data record 132 associated with the certification data record 130.

In some embodiments, the output of step 608 may comprise data describing a certification requirement data record 131 of the plurality of certification requirement data records 131 of the certification data record 130 that is not met by one or more of the data of the medical data record 124, the data of the education data record 125, and the data of the experience data record 127. As an example, the output may comprise text telling the applicant user 101A what action they must perform to complete a requirement they have not met in order to take the test of a certification test data record 132 associated with the certification data record 130.

In some embodiments, the output of step 608 may comprise data describing that each certification requirement data record 131 of the plurality of certification requirement data records 131 of the certification data record 130 has been met by one or more of the data of the medical data record 124, the data of the education data record 125, and the data of the experience data record 127. As an example, the output may comprise text telling the applicant user 101A that they currently meet all of the requirements to take the test of a certification test data record 132 associated with the certification data record 130.

After step 608, method 600 may finish 609.

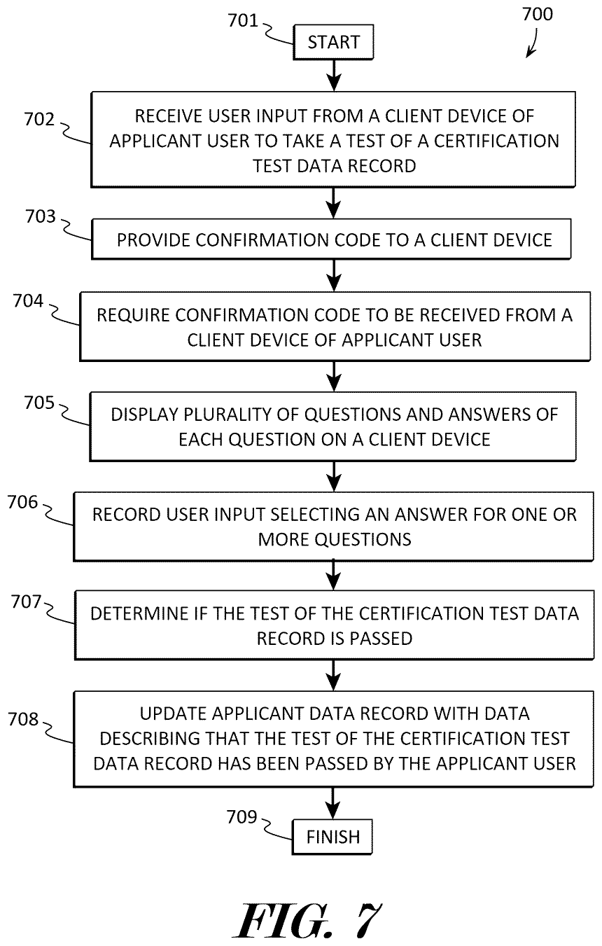

FIG. 7 shows a block diagram of an example of a computer-implemented professional competence assessment method (“method 700”) according to various embodiments described herein. Preferably, method 700 may be used to enable an applicant user 101A, such as a seafarer, to take online tests or examinations in order to earn a license, professional certification, or other credential that verifies someone's knowledge, skills and abilities to perform a specific job. Preferably, method 700 may be used to enable an applicant user 101A to pass tests and exams online, via one or more client devices 400, instead of having to go offline and travel to special testing centers. Program instructions, such as contained in a management program 171, an examination program 172, and a document generator program 173 and stored in one or more computer-readable memories 310, 410, may be executed via one or more processors 302, 402, to cause the system 100 to perform the steps of method 700.

The method 700 may start 701 and user input may be received by a management program 171 via a client device 400 of an applicant user 101 to take a test of a certification test data record 132 in step 702. In some embodiments, management program 171 may generate a graphical user interface 181 on a client device 400 that the applicant user 101A may interact with to provide input that describes that the applicant user 101A desires to take a test of a certification test data record 132. As an example, the user input may be received by a management program 171 via a first client device 400 of an applicant user 101, such as a smartphone, or a second client device 400, such as a desktop or laptop computer. In some embodiments, this input may be used as input to create an application to obtain a certification of a certification data record 130 may be received from an applicant user 101A via a client device 400 of the applicant user 101A in step 604 of method 600.

In step 703, the management program 171 may provide a confirmation code to a client device 400 of the applicant user 101A. A confirmation code may be provided to a client device 400 by the management program 171 via a text message, an email, or any other type of electronic message or data communication that may be provided to a client device 400. A confirmation code may comprise a string of alphanumeric characters or any other type of code that only the client device 400 that received the confirmation code and the system 100 are in possession of. Optionally, the management program 171 may provide the confirmation code to the client device 400 of the applicant user 101A that the applicant user 101A used in the performance of method 600. Preferably, the management program 171 may provide the confirmation code to the client device 400 of the applicant user 101A that was used in step 702.

In step 704, the management program 171 may require the confirmation code to be received from a client device 400 of the applicant user 101A. Optionally, the applicant user 101A may enter the confirmation code to a client device 400 having a graphical user interface 181 operated by the management program 171. As an example, an applicant user 101A may operate their laptop client device 400 in step 702, the confirmation code may be sent to their smartphone client device 400 in step 703, and the applicant user 101A may enter the confirmation code into the laptop client device 400 in step 704. Optionally, the management program 171 operating a graphical user interface 181 on a client device 400 may detect confirmation code being received by the client device 400. As an example, an applicant user 101A may operate their smartphone client device 400 in step 702, the confirmation code may be sent to their smartphone client device 400 via a text message in step 703, and the management program 171 operating a graphical user interface 181 on the smartphone client device 400 may detect the confirmation code received by the smartphone client device 400 in step 704. If the confirmation code is not received from a client device 400 of the applicant user 101A, the method 700 may not continue to step 705.

In step 705, an examination program 172 may display a plurality of questions 133 and the answers 134, 135, of each question 133 on a client device 400 of the applicant user 101A. In some embodiments, the examination program 172 may generate a graphical user interface 181 on the display screen 404A of the applicant user's 101A client device 400 displaying the plurality of questions 133 and the correct answer 134 and one or more incorrect answers 135 of each question 133 of the plurality of questions 133 of the certification test data record 132.

In step 706, an examination program 172 may record user input, via the client device 400 of step 705, selecting an answer 134, 135, for one or more questions 133 displayed to the applicant user 101A. In some embodiments, the user input may be received and recorded via a graphical user interface 181 generated on the display screen 404A of the applicant user's 101A client device 400 by the examination program 172. In preferred embodiments, the examination program 172 may count down a time period 136 that the user input selecting one or more correct answers 134 and/or incorrect answers 135 for one or more questions 133 of the plurality of questions 133 is allowed to be recorded in. For example, the examination program 172 may count down a time period 136 of two hours that the questions 133 and answers 134, 135, may be displayed to the applicant user 101A and in which the applicant user 101A can input their answer 134, 135, selections. Once the time period 136 has elapsed, the examination program 172 may stop displaying questions 133 and recording user input selecting answers 134, 135.

In step 707, the examination program 172 may determine if the test of the certification test data record 132 is passed. In preferred embodiments, the examination program 172 may determine that the test of the certification test data record 132 is passed if a number of correct answers 134 recorded via the client device 400 of step 706 in the time period 136 exceeds a correct answer threshold 137 stored in the system database 120. Continuing the above example, if the correct answer threshold 137 is eighty percent, the applicant user 101A is required to have selected the correct answer 134 for at least eighty percent of the questions 133 of the test of the certification test data record 132 within the two hour time period 136 in order for the examination program 172 to determine that the test of the certification test data record 132 is passed. In preferred embodiments, the examination program 172 may output the determination of whether or not the applicant user 101A has passed the test of the certification test data record 132 on the user's client device 400. For example, “test passed” or “test failed” may be displayed on the user's client device 400.

In step 708, the management program 171 may update the applicant data record 121 of the applicant user 101A with data describing that the test of the certification test data record 132 associated with the application data record 128 and certification data record 130 has been passed by the applicant user 101A. In preferred embodiments, the management program 171 may update the education data record 125 with data describing that the test of the certification test data record 132 has been passed by the applicant user 101A

After step 708, method 700 may finish 709.

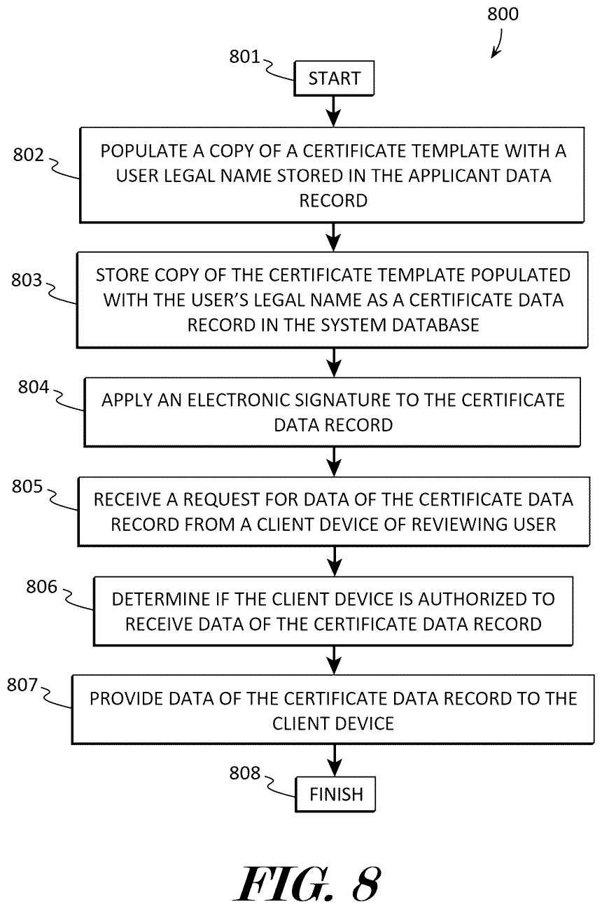

FIG. 8 shows a block diagram of an example of a computer-implemented professional competence document generation method (“method 800”) according to various embodiments described herein. Preferably, method 800 may be used to generate electronic documents, such as a license, professional certification, or other credential that verifies someone's knowledge, skills and abilities to perform a specific job which can then be verified in any point of the world if via an internet network connection 104. Preferably, method 800 may eliminate the need for applicant users 101A, such as seafarers, to keep and maintain paper copies of documents, such as a license, professional certification, or other credential that verifies someone's knowledge, skills and abilities to perform a specific job. In preferred embodiments, method 800 may be performed after completion of step 708 of method 700. Program instructions, such as contained in a management program 171, an examination program 172, and a document generator program 173 and stored in one or more computer-readable memories 310, 410, may be executed via one or more processors 302, 402, to cause the system 100 to perform the steps of method 800.

The method 800 may start 801, and a copy of a certificate template 138 may be populated with a legal name of an applicant user 101A stored in the applicant data record 121 by a document generator program 173 in step 802. In preferred embodiments, the document generator program 173 may populate a copy of the certificate template 138 with the legal name of the applicant user 101A stored in the identification data record 123 of the applicant user's 101A applicant data record 121.

In step 803, the document generator program 173 may store the copy of the certificate template 138 populated with the user's legal name as a certificate data record 126 in the system database 120.

In step 804, the document generator program 173 may apply an electronic signature to the certificate data record 126 so that the electronic signature is stored in the certificate data record 126.

In step 805, the management program 171 may receive a request for data of the certificate data record 126 from a client device 400 of user 101, such as a reviewing user 101B. A reviewing user 101B may comprise an individual or entity that may need to verify and review licenses, certificates, training, and certification of one or more applicant users 101A.

In step 806, the management program 171 may determine if the client device 400 of the reviewing user 101B is authorized to receive data of the certificate data record 126. A reviewing user 101B may log into the system 100, such as with a user name and password, using their client device 400 to verify that the requesting client device 400 is being operated by a reviewing user 101B. In some embodiments, an applicant user 101A may use their client device 400 to provide user input to the management program 171 that identifies one or more reviewing users 101B that are authorized to receive data of the certificate data record(s) 126 of the applicant user 101A. In some embodiments, if the login credentials provided via a client device 400 match a reviewing user 101B identified by the applicant user 101A, the management program 171 may determine that the client device 400 of the reviewing user 101B is authorized to receive data of the certificate data record 126. In further embodiments, if the login credentials provided via a client device 400 do not match a reviewing user 101B identified by the applicant user 101A, the management program 171 may determine that the client device 400 of the reviewing user 101B is authorized to receive data of the certificate data record 126. If the management program 171 determines that the client device 400 of a user 101, such as the reviewing user 101B is not authorized to receive data of the certificate data record 126, the method 800 may not proceed to step 807.

In step 807, the management program 171 may provide data of the certificate data record 126 to the client device 400 of the requesting user 101B if it is determined that the client device 400 of the requesting user 101B is authorized to receive data of the certificate data record 126. In preferred embodiments, the management program 171 may display the certificate data record having the user's legal name and the electronic signature as an electronic document on a display screen 404A of the client device 400. In further preferred embodiments, the management program 171 may provide data of the certificate data record 126 to the client device 400 by generating an image of a certificate, license, or other document that identifies an individual as having successfully passed a test or examination for a license, professional certification, or other credential that verifies someone's knowledge, skills and abilities to perform a specific job in which the image includes the applicant user's 101A legal name and one or more electronic signatures. Preferably, by providing data of the certificate data record 126 to the client device 400 by generating an image of a certificate, license, or other document that identifies an individual as having successfully passed a test or examination for a license, professional certification, or other credential that verifies someone's knowledge, skills and abilities to perform a specific job in which the image includes the applicant user's 101A legal name and one or more electronic signatures in step 807, the need for applicant users 101A, such as seafarers, to keep and maintain paper copies of documents, such as a license, professional certification, or other credential that verifies someone's knowledge, skills and abilities to perform a specific job may be eliminated.

After step 807, the method 800 may finish 808.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface, such as a web-based graphical user interface or a Web browser, through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to a processor for execution. For example, the instructions may initially be carried on a magnetic disk of a remote computer. The remote computer can load the instructions for implementing all or a portion of the present invention remotely into a dynamic memory and send the instructions over the air (e.g., through a wireless cellular network or WIFI network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on a storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetric digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A professional competence assessment system, the system comprising:
a system database having a certification data record that is associated with a plurality of certification requirement data records;
program instructions stored in one or more computer-readable memories; and
one or more processors configured to execute the program instructions to cause the system to perform operations comprising:
receiving a digital picture of an applicant user, a digital copy of a passport of the applicant user, a digital copy of a medical record of the applicant user, a digital copy of an education record of the applicant user, and a digital copy of an experience record of the applicant user;
generating an applicant data record for the applicant user in the system database, the applicant data record having a user image data record, an identification data record, a medical data record, an education data record, and an experience data record;
receiving user input from the applicant user, via a first client device, to create an application to obtain a certification of the certification data record;
generating an application data record in system database corresponding to the application, the application data record associated with the applicant data record;
determining if the plurality of certification requirement data records are met by data of the medical data record, data of the education data record, and data of the experience data record; and
generating a status data record that is associated with the application data record, wherein the status data record comprises data describing if the plurality of certification requirement data records are met by the data of the medical data record, data of the education data record, and data of the experience data record.

2. The system of claim 1, wherein the one or more processors are configured to execute the program instructions to cause a graphical user interface to be generated on the first client device that displays data of the applicant data record.

3. The system of claim 2, wherein the one or more processors are configured to execute the program instructions to cause the graphical user interface to display an output describing that each certification requirement data record of the plurality of certification requirement data records is not met by one of the data of the medical data record, the data of the education data record, and the data of the experience data record.

4. The system of claim 3, wherein the one or more processors are configured to execute the program instructions to cause the graphical user interface to display an output having data describing a certification requirement data record of the plurality of certification requirement data records that is not met by one of the data of the medical data record, the data of the education data record, and the data of the experience data record.

5. The system of claim 2, wherein the one or more processors are configured to execute the program instructions to cause the graphical user interface to display an output describing that each certification requirement data record of the plurality of certification requirement data records is met by one of the data of the medical data record, the data of the education data record, and the data of the experience data record.

6. The system of claim 5, wherein the certification data record is associated with a certification test data record in the system database, the certification test data record having a plurality of questions and each question of the plurality of questions having a correct answer and one or more incorrect answers.

7. The system of claim 6, wherein the one or more processors are configured to execute the program instructions to cause the system to perform operations comprising: receiving user input from the applicant user, via a second client device, to take a test of the certification test data record.

8. The system of claim 7, wherein the one or more processors are configured to execute the program instructions to cause the system to perform operations comprising: providing a confirmation code to the first client device.

9. The system of claim 8, wherein the one or more processors are configured to execute the program instructions to cause the system to perform operations comprising: requiring the confirmation code to be entered via the second client device in order for the test of the certification test data record to be taken on the second client device.

10. The system of claim 9, wherein the one or more processors are configured to execute the program instructions to cause the system to perform operations comprising: displaying the plurality of questions and the correct answer and one or more incorrect answers of each question of the plurality of questions of the certification test data record on a display screen of the second client device; and recording, via the second client device, user input selecting one of the correct answer and the one or more incorrect answers for one or more questions of the plurality of questions.

11. The system of claim 10, wherein the one or more processors are configured to execute the program instructions to cause the system to perform operations comprising: counting down a time period that the user input selecting one of the correct answer and the one or more incorrect answers for one or more questions of the plurality of questions is allowed to be recorded in.

12. The system of claim 11, wherein the one or more processors are configured to execute the program instructions to cause the system to perform operations comprising: determining that the test of the certification test data record is passed if a number of correct answers recorded via the second client device in the time period exceeds a correct answer threshold stored in the system database.

13. The system of claim 12, wherein the one or more processors are configured to execute the program instructions to cause the system to perform operations comprising: updating the education data record with data describing that the test of the certification test data record has been passed by the applicant user.

14. The system of claim 12, further comprising a certificate template stored in the system database and associated with the certification test data record.

15. The system of claim 14, wherein the one or more processors are configured to execute the program instructions to cause the system to perform operations comprising: populating a copy of the certificate template with a legal name of the applicant user stored in the applicant data record; and storing the copy of the certificate template populated with the user's legal name as a certificate data record in the system database.

16. The system of claim 15, wherein the one or more processors are configured to execute the program instructions to cause the system to perform operations comprising: applying an electronic signature to the certificate data record.

17. The system of claim 16, wherein the one or more processors are configured to execute the program instructions to cause the system to perform operations comprising: receiving a request for data of the certificate data record from a third client device.

18. The system of claim 17, wherein the one or more processors are configured to execute the program instructions to cause the system to perform operations comprising: determining that the third client device is authorized to receive data of the certificate data record; and providing data of the certificate data record to the third client device if it is determined that the third client device is authorized to receive data of the certificate data record.

19. The system of claim 18, wherein the one or more processors are configured to execute the program instructions to cause the system to perform operations comprising: displaying the certificate data record having the user's legal name and the electronic signature as an electronic document on a display screen of the third client device.

20. The system of claim 1, wherein the system database is encrypted.
